(19) United States
(12) Patent Application Publication
(10) Pub. No.: US 2012/0117189 A1
(43) Pub. Date: May 10, 2012

(54) METHOD AND APPARATUS FOR OBTAINING FEEDBACK FROM A DEVICE

(75) Inventors: Tom Lam, Chula Vista, CA (US); Robert Cowie, Escondido, CA (US); Peter Tat, San Diego, CA (US); Don Nguyen, San Marcos, CA (US); Tam Dao, San Marcos, CA (US); Guoxuan Zhang, San Diego, CA (US)

(73) Assignee: Sony Corporation, Tokyo (JP)

(21) Appl. No.: 13/289,655

(22) Filed: Nov. 4, 2011

Related U.S. Application Data
(60) Provisional application No. 61/412,030, filed on Nov. 10, 2010.

(51) Int. Cl. G06F 15/16

(52) U.S. Cl. 709/217; 709/224

(57) ABSTRACT

An apparatus and method for utilizing user feedback of a user device. The method includes identifying state information of the CPU and obtaining usage information when the CPU is identified to be in a processing state. The average CPU usage is calculated and the CPU is upgraded based on the calculated average.

### CLAIM TO PRIORITY

This application claims the benefit of previously filed U.S. Provisional Application 61/412,030 filed Nov. 10, 2010 entitled “VAIO Care Metrics” by Lam et al. The entirety of which is hereby incorporated by reference herein.

### BACKGROUND

1. Field of the Invention

This invention relates generally to a system and method of utilizing user feedback of a user device and more specifically to obtaining and analyzing user feedback.

2. Background Discussion

Generally, customer feedback of a user device, such as a personal computer, cell phone, PDA, television, PLAYSTATION™, PSP™ and the like, can be collected through surveys, call centers, or focus groups. Typically, conventional processing of feedback has several disadvantages. First, the customer feedback collected by this process does not have an effect on the development process since the development cycle is over by the time the machine is in the customers' hands. Second, it is too costly to conduct focus groups. It is also costly to have customers call in for software issues, for example, questions like “How do I burn a disc”, “Where do I go to find help”. Third, the manufacturer cannot directly gauge if customers are actually using their computer's software and hardware. Indeed, in many instances, when customers were asked about pre-installed device software on their computer many customers claimed to have used software that was not even installed on their device.

### SUMMARY

One embodiment of the present invention is directed to a method and apparatus (the method) for utilizing user feedback of a user device. The method includes identifying CPU state information for the user device and obtaining CPU usage when CPU is at p-state. An average CPU usage is calculated and the CPU is upgraded based on the calculated average CPU usage.

Another embodiment of the present invention is directed to the method described above and also includes determining whether the calculated average CPU usage is greater than a predetermined threshold usage.

Yet another embodiment of the present invention is directed to the method described above wherein the CPU state information indicates the CPU is at p-state, c-state and s-state.

Yet another embodiment of the present invention is directed to the method described above and also includes making recommendations for upgrading the CPU, when the calculated average CPU usage is greater than the predetermined threshold.

Yet another embodiment of the present invention is directed to the method described above and further includes upgrading the CPU based on a product bucket identification (ID).

Yet another embodiment of the present invention is directed to the method described above and also includes creating a user account for each user and collecting use pattern data for each user.

Yet another embodiment of the present invention is directed to the method described above and also includes identifying the product bucket identification (ID) and collecting usage information for a plurality of products having a same product bucket identification (ID). The collected usage information is used to generate recommendations for upgrading the CPU based on the product bucket identification (ID).

Yet another embodiment of the present invention is directed to the method described above and also includes upgrading CPU based on the user's request.

Yet another embodiment of the present invention is directed to the method described above wherein the upgrading step includes design modifications for other CPU devices.

Yet another embodiment of the present invention is directed to a client device that includes a user account module that stores use pattern data for a user, the use pattern data including CPU state information for the user device. A transmission module transmits the use pattern data to a remote location. A reception module receives processed data, the processed data being a function of the use pattern data and the CPU state information. A processor module utilizes the processed data to upgrade the CPU based on the received processed data.

Yet another embodiment of the present invention is directed to the client device described above and also includes a display unit that displays an indication of the CPU status.

Yet another embodiment of the present invention is directed to the client device as described above, wherein the use pattern data is updated at a predetermined time interval.

Yet another embodiment of the present invention is directed to the client device as described above, wherein the CPU state information indicates the CPU is at p-state, c-state and s-state.

Yet another embodiment of the present invention is directed to the client device as described above, wherein the processed data includes recommendations for upgrading the CPU, when a calculated average CPU usage is greater than a predetermined threshold.

Other embodiments of the present invention include the methods described above but implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates an example of a network that supports embodiments of the present invention.

FIG. 2 shows an example of information flow according to an embodiment of the present invention.

FIG. 3 shows a block diagram of a representative processing device.

FIG. 4 illustrates an example of usage data according to an embodiment of the present invention.

FIG. 5 illustrates an example of application usage data (AUD) in XML version according to an embodiment of the present invention.

FIG. 6 illustrates an example of system usage data (SUD) in XML version according to an embodiment of the present invention.

FIG. 7 illustrates an example of program to read and compare system usage data according to an embodiment of the present invention.

FIG. 8 illustrates an example of an AUD database according to an embodiment of the present invention.

FIG. 9 illustrates an example of a SUD database according to an embodiment of the present invention.

FIG. 10 illustrates an example of website presenting the results of data analysis according to an embodiment of the present invention.

FIG. 11 shows a flowchart illustrating an embodiment of the present invention.

FIG. 12 shows a block diagram of a client device according to an embodiment of the present invention.

FIG. 13 shows a flowchart of steps according to an embodiment of the present invention.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with each other and/or one or more electronic storage media.

Embodiments of the present invention may be implemented using one or more processing devices, or processing modules. The processing devices, or modules, may be coupled such that portions of the processing and/or data manipulation may be performed at one or more processing devices and shared or transmitted between a plurality of processing devices or modules.

Indeed, the present invention may be implemented in a distributed or “cloud” computing environment in which shared resources, software and information are provided to computers and other devices over a network, which may be, for example, the Internet. “Cloud computing” typically involves delivering hosted services over the Internet. A cloud service typically has three distinct characteristics that differentiate it from traditional hosting. One characteristic is that it is sold on demand, typically by the minute or the hour; secondly, it is elastic—a user can have as much or as little of a service as they want at any given time; and thirdly, the service is usually fully managed by the provider (the consumer needs nothing but a personal computer and Internet access). Significant innovations in virtualization and distributed computing, as well as improved access to high-speed Internet have accelerated interest in cloud computing. The cloud can be private or public. A public cloud typically sells services to anyone on the Internet. (Currently, Amazon Web Services™ is the largest public cloud provider.) A private cloud is a proprietary network or a data center that supplies hosted services to a limited number of people. When a service provider uses public cloud resources to create their private cloud, the result is called a virtual private cloud. Private or public, the goal of cloud computing is to provide easy, scalable access to computing.

“Distributed computing”, or “distributed systems” relate to a system of multiple autonomous computers or processing devices or facilities that communicate through a network. The computers interact with each other in order to achieve a particular goal. A computer program that runs in a distributed system is typically referred to as a “distributed program” and “distributed programming” is the process of writing such programs. Distributed computing also refers to the use of distributed systems to solve computational problems. Typically, in distributed computing, a problem is divided into multiple tasks, each of which is solved by one or more computers. In general, distributed computing is any computing that involves multiple computers remote from each other that each has a role in a computation problem or information processing.

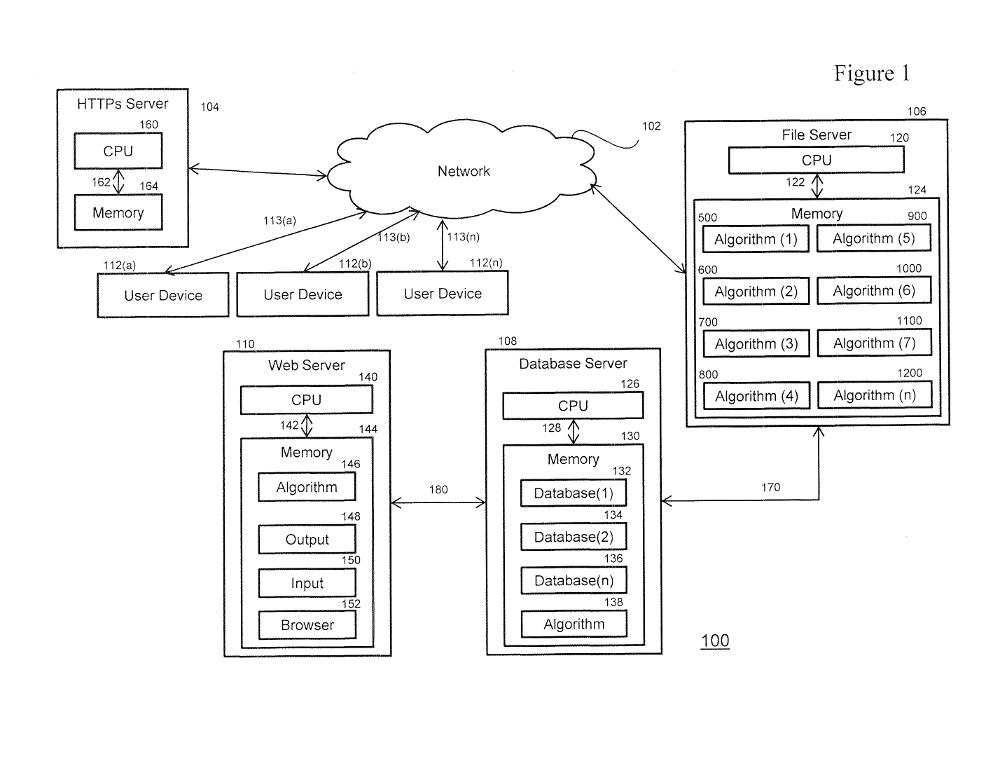

FIG. 1 shows a network environment 100 that supports embodiments of the present invention. As shown in FIG. 1, the system includes a communication network 102, an HTTPs server 104, a file server 106, a database server 108, a web server 110, and a plurality of user devices 112(a), 112(b) . . . 112(n) (where “n” is any suitable number).

The network 102 is, for example, any combination of linked computers, or processing devices, adapted to transfer and process data. The network 102 may be private Internet Protocol (IP) networks, as well as public IP networks, such as the Internet that can utilize World Wide Web (www) browsing functionality. An example of a wired network is a network that uses communication buses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

The HTTPs server module, or facility, or unit, 104 is typically one or more processors with associated memory, such as computers, or other processing devices such as a desktop computer and the like. The HTTPs server 104 may also be used as an external server to which gather usage data is sent from the user devices. The HTTPs server 104 includes CPU 160, which is operatively coupled to memory 164 via interconnection medium 162. The CPU 160 is a processing unit that typically includes an ALU and is configured to perform processing operations and manipulations. Memory 164 is typically an electronic storage medium that stores data in electronic format.

The file server module, or facility, or unit, 106 is typically a server, computer, or other processing devices such as a desktop computer, laptop computer, and the like. The server module 106 includes one or more processors 120 bi-directionally coupled with associated memory module 124 via wired or wireless medium 122. The memory module 124 of the file server 106 may comprise a plurality of algorithm storage modules 500, 600, 700, 800, 900, 1000, 1100 and 1200. The file server 106 may also be an internal server for processing data sent from the HTTPs server 104.

The database server module, or facility, or unit, 108 typically includes one or more processors 126 bi-directionally coupled with associated memory 130 via wired or wireless medium 128. Database server module 108 is typically a computer, server or other processing device such as a desktop computer, laptop computer, and the like. The memory 130 comprises an algorithm 138 for data analysis and a plurality of databases, database (1) 132, database (2) 134 . . . database (n) 136, (where “n” is any suitable number) for storing data. The database server 108 is used as a server for data analysis.

Similarly, the web server module, or facility, or unit, 110 typically includes one or more processors 140 bi-directionally coupled with associated memory 144 via wired or wireless medium 142. Web server module 110 includes computers, or other processing devices such as a desktop computer, laptop computer, and the like. The memory 144 comprises an algorithm 146, output means 148, such as a monitor, input means 150, such as a keyboard or mouse, and browser software 152. The web server 110 is used as a server to host and build website.

It is noted that the file server 106, the database server 108 and the web storage 110 may be a single server, and also may be implemented as one or more separate servers, which may be used in a cloud computing or distributed computing environment.

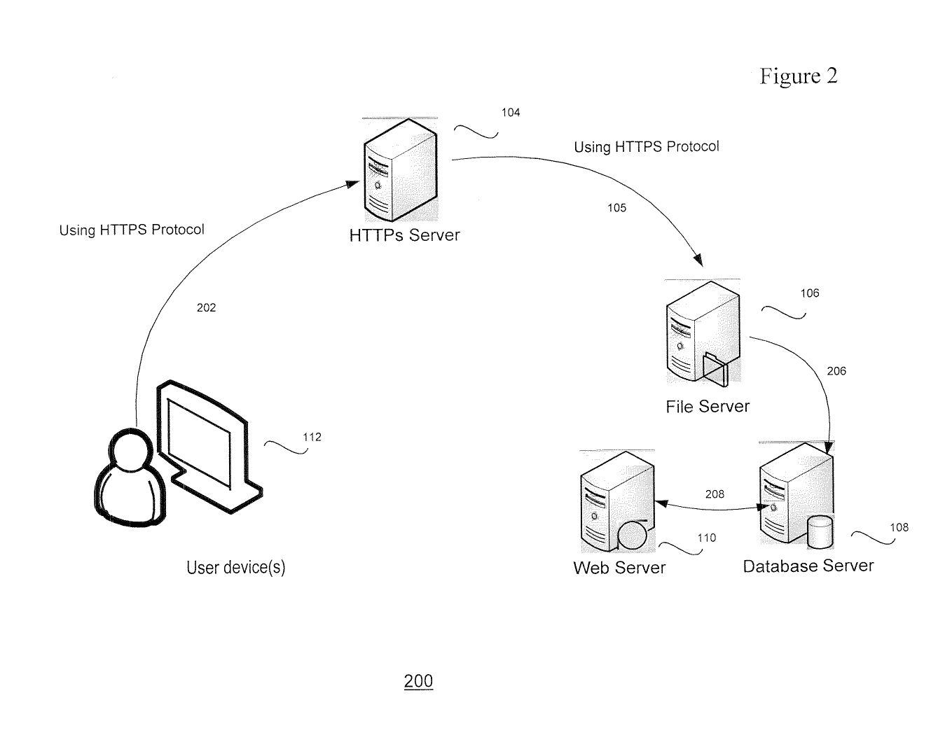

User devices 112(a), 112(b) . . . 112(n) (where “n” is any suitable number) are connected directly to the communication network 102, via associated communication medium 113(a) . . . (n). User device 112 may be any suitable consumer electronic (CE) unit or module or device. As shown in FIG. 2, the user devices may be computer products.

The HTTPs server 104, the file server 106 and the user devices 112(a), 112(b) . . . 112(n) are coupled to network 102 via an associated bi-directional communication medium, which may be for example a serial bus such as IEEE 1394, or other wire or wireless transmission medium. Also, web server 110 is in bi-directional communication with database server 108 via communication medium 180, which may be a wire or wireless connection. Database server 108 is in bi-directional communication with file server 106 via communication medium 170, which may be a wire or wireless connection.

FIG. 2 shows an alternative network environment 200 that supports embodiments of the present invention. As shown in FIG. 2, the system includes a HTTPs server 104, a file server 106, a database server 108, and a web server 110, where the file server 106 and the database server 108 are connected via a bi-directional medium 206, and the database server 108 and web server 110 are connected via a bi-directional medium 208. The HTTPs server 104 is operatively coupled to file server 106 via interconnection medium 105, which may be a wire or wireless connection. The system 200 also includes user device 112 connected to the HTTPs Server 104 via a bi-directional medium 202 and may be connected using HTTPs protocol. While only one user device 112 is shown in FIG. 2, it is an embodiment of the present invention that a plurality of user devices 112 may be utilized.

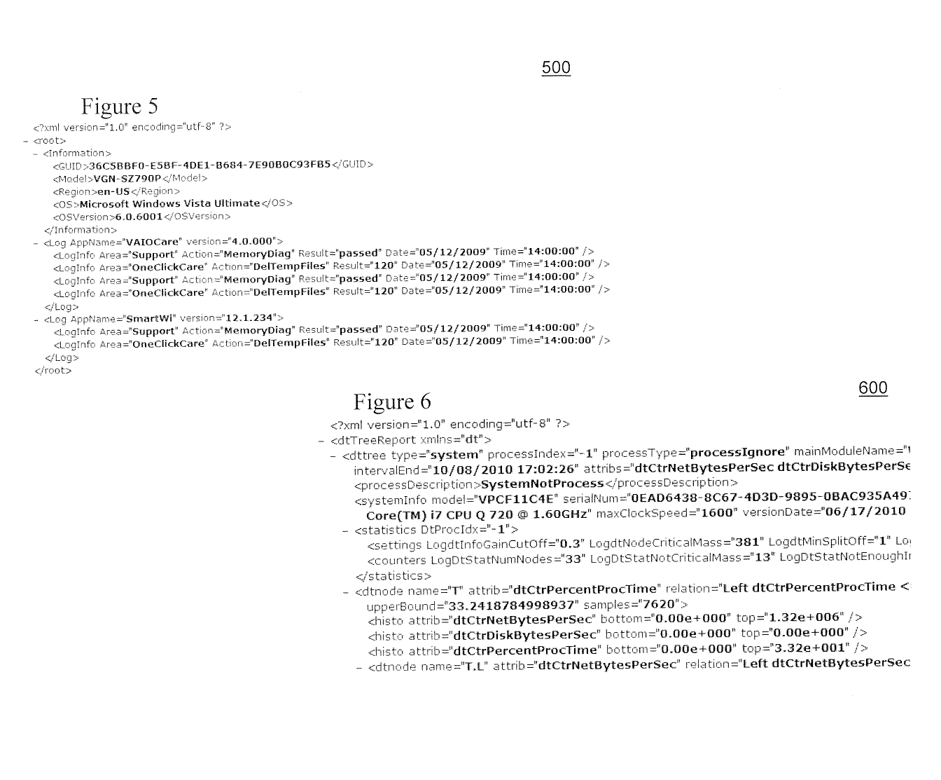

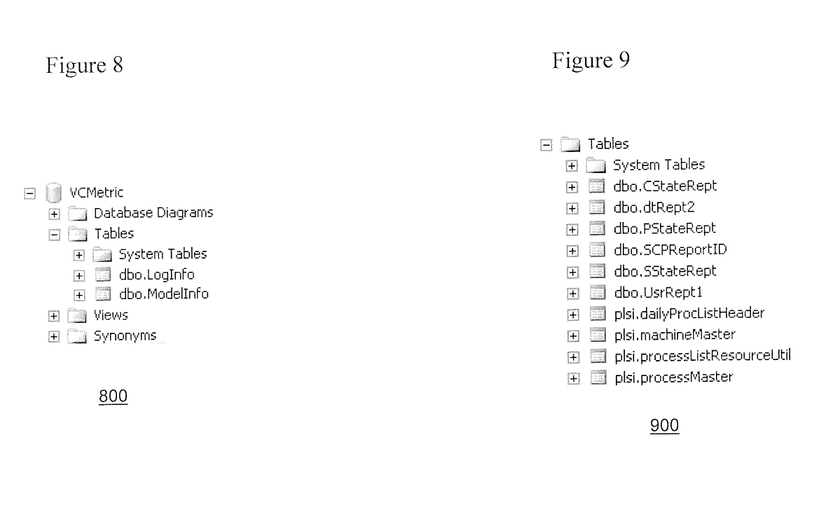

Application Usage Data (AUD) (FIG. 5) and System Usage Data (SUD) (FIG. 6) are collected at user device 112. At a predetermined time, an upload process at the user device 112 zips and encrypts the data and sends the zipped and encrypted data to the HTTPs Server 104 using any suitable protocol, such as, for example, FTPs, SOAP, or HTTPS protocol, shown as element 202. For example, using the HTTPS protocol for secure transmission, the data is sent to the file server 106 via a communication medium 105. From there, the data is sent to the database server 108 via communication medium 206. The database server 108 comprises two core tables, which are described in more detail with respect to FIGS. 8 and 9.

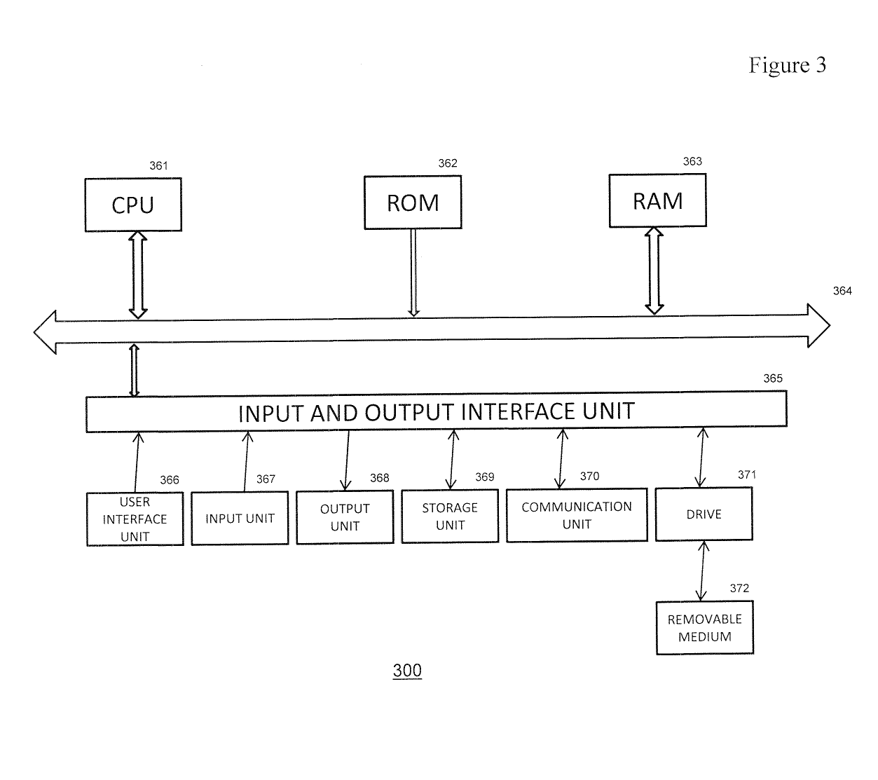

The invention disclosed herein may be practiced using programmable digital computers. FIG. 3 is a block diagram 300 of a representative computer system. The computer system 300 includes at least one processor 361, such as an Intel Core™ 2 microprocessor or a Freescale™ PowerPC™ microprocessor, coupled to a communications channel 364. The computer system 300 further includes an input and output interface unit 365. Coupled to the input and output interface unit 365 are a user interface unit 366, an input device, or unit 367 such as, e.g., a keyboard or mouse, an output device, or unit 368 such as, e.g., a CRT or LCD display, a communications unit 370, a data storage device, or unit 369 such as a magnetic disk or an optical disk, and drive 371, such as a CD-ROM, DVD-ROM, capable of reading/writing data onto a removable medium 372. Read Only Memory (ROM) 362 and Random-Access Memory (RAM) 363 are each coupled to the communications channel 364. The communications unit 370 may be coupled to a network such as the Internet. Moreover, the computer system 300 may be equipped with a browser program suitable for communication with the World Wide Web.

One skilled in the art will recognize that, although the data storage device, or unit 369 and memory 362, 363 are depicted as different units, the data storage unit 369 and memory 362, 363 can be parts of the same unit or units, and that the functions of one can be shared in whole or in part by the other, e.g., as RAM disks, virtual memory, etc. It will also be appreciated that any particular computer may have multiple components of a given type, e.g., processors 361, input devices 367, communications unit 370, etc.

The data storage device 369 and/or memory 362, 363 may store an operating system such as Microsoft Windows 7®, Windows XP® or Vista™, Linux®, Mac OS®, or Unix®, Other programs may be stored instead of or in addition to the operating system. It will be appreciated that a computer system may also be implemented on platforms and operating systems other than those mentioned. Any operating system or other program, or any part of either, may be written using one or more programming languages such as, e.g., Java®, C, C++, C#, Visual Basic®, VB.NET®, Peri, Ruby, Python, or other programming languages, possibly using object oriented design and/or coding techniques. These platforms and operating systems may be accessed in a cloud computing or distributed computing environment.

The computer system 300 may also include additional components and/or systems, such as network connections, additional memory, additional processors, network interfaces, input/output ports or busses. Also the programs and data may be received by and stored in the system in alternative ways. For example, a computer-readable storage medium (CRSM) reader, such as, e.g., a magnetic disk drive, magneto-optical drive, optical disk drive, or flash drive, may be coupled to the communications bus 364 for reading from a computer-readable storage medium (CRSM) such as, e.g., a magnetic disk, a magneto-optical disk, an optical disk, or flash RAM. Accordingly, the computer system 300 may receive programs and/or data via the CRSM reader. Further, it will be appreciated that the term “memory” herein is intended to include various types of suitable data storage media, whether permanent or temporary, such as transitory electronic memories, non-transitory computer-readable medium and/or computer-writable medium.

Two or more computer systems 300 may be connected, e.g., in one or more networks, via, e.g., their respective communications interfaces and/or network interfaces (not depicted).

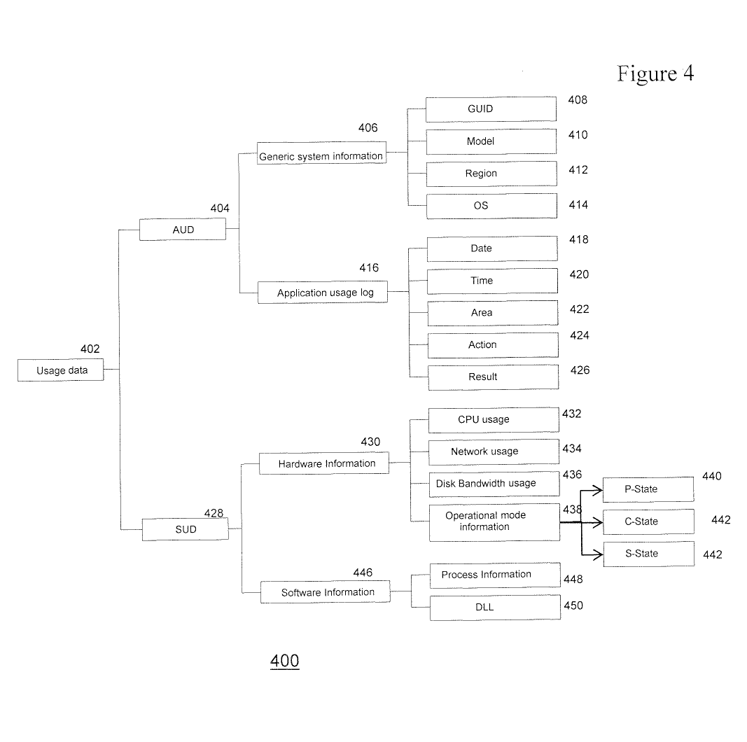

FIG. 4 illustrates an example 400 of usage data 402 according to an embodiment of the present invention. Usage data 402 is broken down into two types of data, Application Usage Data (AUD) 404 and System Usage Data (SUD) 428.

AUD 404 is comprised of Generic System information 406 and an Application Usage Log 416. The Generic System Information 406 is comprised of a randomly generated ID for the system called a Globally Unique Identifier (GUID) 408 which allows the system to maintain a history of data recorded on a computer without reporting any personal identifiable information this maintaining user privacy, model information 410, which is the model of the system, region information 412, which includes information on what language the user of the system selected, and OS information 414, which includes what operating system and what version of that operating system that the system is running.

The Application Usage Log 416 comprises date information 418, time information 420, area information 42, which includes data indicating where an action occurred, action information 424, which includes data on what action occurred, e.g. a click, and result information 426, which includes data indicating the result from the action.

SUD 428 is comprised of Hardware information 430 and Software information 446. Hardware information 430 comprises CPU usage data 432, network usage data 434, disk bandwidth data 436, and operation mode information 438. The operation mode information may comprise P-State information 440 indicating the voltage and frequency of the CPU, C-State information 442 indicating which of several included power state modes that the CPU is operating in, and S-State information 444 indicating a system in Standby/Sleep/Hibernate mode.

The software information 446 comprises Process Information 448, which comprises a list of all processes ran on the system, their descriptions, when it was ran, how much CPU, Disk, and Network bandwidth was used, and how often it was used. The software information 446 further comprises DLL information 450, which is a list of all DLLs associated with each process, their descriptions, when it was run, how much CPU, Disk, and Network bandwidth, was used and how often it was used.

FIG. 5 illustrates an example 500 of application usage data (AUD) in XML version according to an embodiment of the present invention. The XML is used to track all clicks of user input and allow data mining to summarize which features are used or unused.

FIG. 6 illustrates an example 600 of system usage data (SUD) in XML version according to an embodiment of the present invention. In one embodiment, the code for SUD is written in native C++, the program has minimal impact on the system ecosystem (operating speed, processor capacity utilized, power consumption, memory space utilized etc.). A program is written to translate the XML of the SUD data into a readable format that can be used for analysis.

After the Application Usage Data (AUD) and System Usage Data (SUD) are gathered, an upload process zips and encrypts a data file. The data file is then transmitted using HTTPS protocol for secure transaction. The zipping, encrypting, and uploading can be written as generic code so that other applications may use the same methods. AUD and SUD may be sent to the file server at any predetermined or requested time. For example, AUD may be sent to the file server once per month and SUD may be sent to the file server once per week.

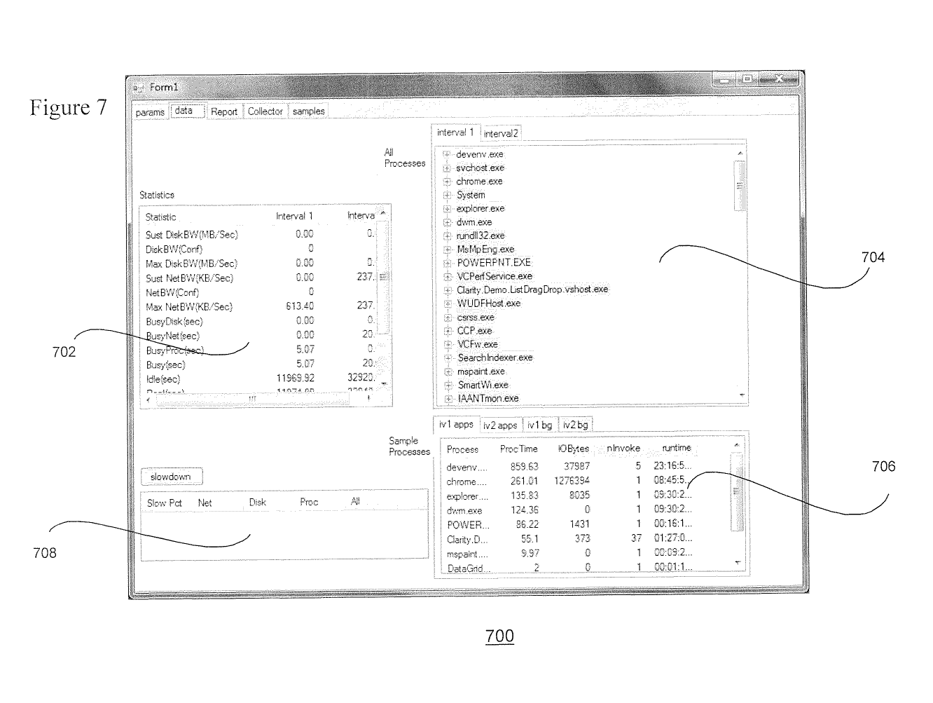

FIG. 7 illustrates an example 700 of program code to read and compare SUD according to an embodiment of the present invention. In FIG. 7, portion 702 shows hardware information, portion 704 shows software information, portion 706 shows sample processes and portion 708 shows a menu.

Portion 702 shows an example of statistics. This is illustrated as three columns of “statistic” “interval 1” and “interval 2”. The statistic column lists various categories, such as “Sust Disk BW(MB/sec)”; “Disk BW (conf)”; “Max Disk BW(MB/Sec)”; “Sust NetBW(KB/Sec)” and others, as shown in area 702.

Portion 704 shows a list of processes that may be executed. As shown in portion 704, these may include “devenv.exe”; “svchost.exe”; “chrome.exe”; “System” and others, as shown in portion 704. The software information 704 may be organized with different color highlighting. While FIG. 7 is shown in a black-and-white scheme, it is also an embodiment of the present invention that various components and elements may be represented using a color output. For example, green highlights may indicate user launch processes, pink highlights may indicate system processes, and blue highlights may indicate unknown processes.

Portion 706 shows sample processes. This includes, for example, a listing of a “process”, “process time”, “i0Bytes”, “nInvoke”; “runtime”. The “process” list includes sample processes of the portion 704.

Portion 708 shows a menu sub-screen with headings “Slow Pct”; “Net”; “Disk”; “Proc” and “All”. Additional headings may also be used in portion 708.

FIG. 8 illustrates an example of AUD database 800 according to an embodiment of the present invention. As shown in FIG. 8, a display of various database outputs is provided. Specifically, FIG. 8 shows a representation of how MS SQL categorized different database items to the end user. While FIG. 8 shows an example of MS SQL categorization, any other suitable categorization scheme could also be used.

FIG. 9 illustrates an example of SUD database 900 according to an embodiment of the present invention. The SUD data includes database items output in a particular format. Specifically, FIG. 9 shows a representation of how MS SQL categorized different database items to the end user. While FIG. 9 shows an example of MS SQL categorization, any other suitable categorization scheme could also be used.

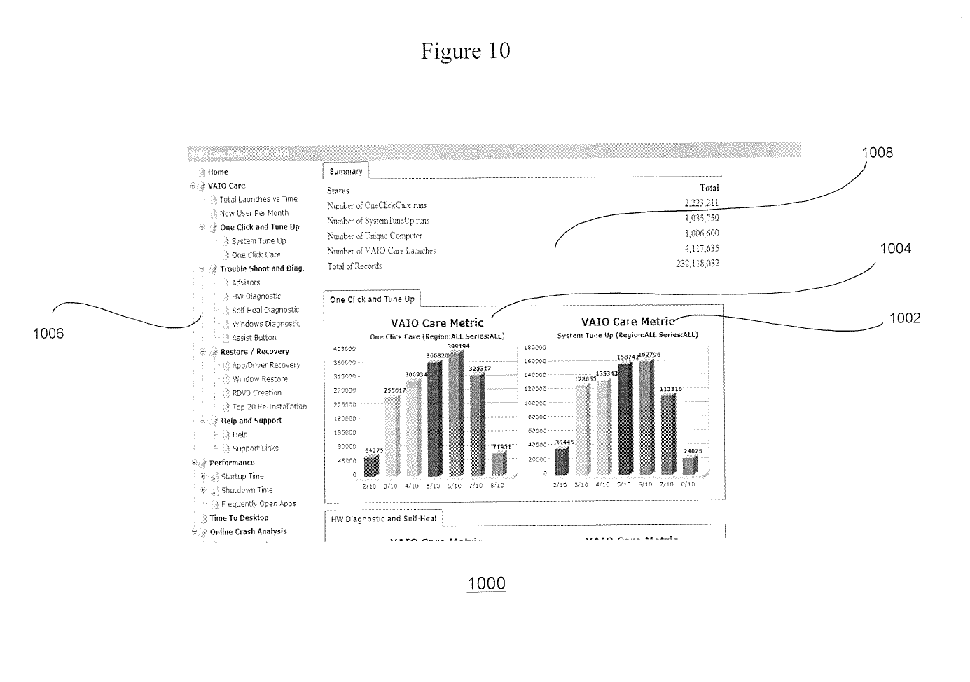

FIG. 10 illustrates an example 1000 of a display, such as a webpage of a website that presents the results of data analysis according to an embodiment of the present invention. To analyze data stored in the databases, one or more processors may be used, functioning together and/or separately (local or remote), for example in a cloud computing or distributed computing environment, to process or manipulate data obtained about device usage. This data may be displayed on a webpage of a website. When a query is performed, by an operator, using the website, data may be requested from the web server (shown in FIG. 1 as element 110) to the database server (shown in FIG. 1 as element 108). One embodiment of a suitable webpage is shown in FIG. 10 as web page display 1000. This web page display 1000 includes an area to display graphical representations 1002, 1004; folder portion 1006 and summary portion 1008.

Portions 1002 and 1004 are areas used to display graphical representations. Specifically, graphical representations 1002 and 1004 illustrate a pictorial representation of collected data.

Portion 1008 shows a summary area that provides a display or output in tabulated or written form.

Portion 1006 shows a listing a various folders and categories of the system, as described herein. These categories include, for example, “One Click and Tune Up”; “Trouble Shoot and Diag.”; “Restore/Recovery”; “Help and Support”; “Performance”; “Time To Desktop”; “Online Crash Analysis” etc.

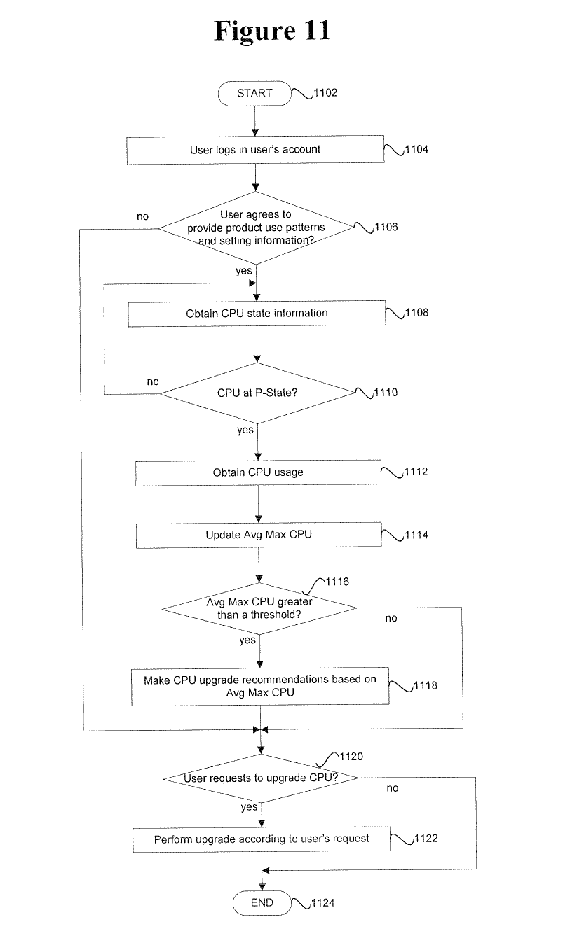

FIG. 11 shows a flowchart illustrating a process 1100 of another embodiment of the present invention. The steps 1100 may be stored on a suitable electronic storage medium, such as a computer-readable medium. The storage location may be any of the memory locations described herein in File Server, Data Base Server, HTTPs server, or other remote or local memory. The steps 1100 describe an algorithm to identify a troubleshooting process and modify troubleshooting. Specifically, the process 1100 starts at step 1102 and user the logs into a user account, as shown in step 1104. In step 1106, the user may agree to product use pattern data acquisition and setting information. If the user does not agree to provide the information, the process skips ahead to step 1120, which will be discussed in detail. If, in step 1106, the user agrees to share the product use pattern information and setting information, CPU state information is obtained, as shown in step 1108.

Next, in step 1110, the process determines whether the CPU is a P-state, based on the obtained state information. If it is determined that the CPU is not in at P-state, the process goes back to step 1108. The process may check again immediately, whether the CPU is in a P-State or wait a pre-determined amount of time. If, at step 1110, the CPU is determined to be at a P-state, CPU usage information is obtained, as shown in step 1112. After the CPU usage information is obtained, the information is stored and previously acquired information may be updated, re-calculated, or calculated. For example, an average CPU usage calculation may be performed using previously obtained CPU usage information and the current CPU usage information. Once the calculation is made, the previously stored average CPU usage information may be updated.

As another example, a maximum CPU usage may be stored in memory. If the CPU usage information obtained in 1112 is determined to be greater than the stored SPU usage information, the newly obtained information is stored. As another example, CPU usage (average or maximum) may be calculated over a predetermined period of time or at an instantaneous point in time, or a predetermined time of day. In step 1114, average maximum CPU usage information is calculated and updated.

After the CPU usage information is obtained, the process determines whether an average maximum CPU usage is greater than a threshold in step 1116. If during the process, the determination is no, the process proceeds to step 1120, which will be described later. However, if at step 1116, the process determines yes, e.g. the average maximum CPU usage is greater than a threshold, the process proceeds to step 1118. At step 1118, an upgrade recommendation based on the average maximum CPU usage information is made. For example, one recommendation may be made if the average maximum CPU usage is meets a specific threshold and another for a different specific threshold, or one recommendation may be made if the average maximum SPU usage falls within a specific range and another recommendation is made if the average maximum CPU usage is in a different specific range.

In step 1120, a user is presented with a choice to upgrade the CPU. The process arrives at step 1120 when (1) the user does not agree to provide product use pattern data or setting information, (2) when the calculated average maximum CPU usage is below a certain threshold, or (3) when the average maximum CPU usage is greater than a threshold and the process has made a recommendation. From step 1120, the process may proceed to perform an upgrade when the user answers yes at step 1120 and chooses to upgrade the CPU. If the user instead chooses no at step 1120, the process proceeds to end at 1124. After the upgrade is performed in step 1122, the process proceeds to end 1124.

It is also noted that according to the recommender program described above, the obtained usage information, such as use patterns and setting information of a user's account, could also be used for data mining based on other components of the user device. For example, similar to the program for making CPU upgrading recommendations, the system may also make upgrading recommendations to other components, such as motherboard, power supply, removable media devices, secondary storage, graphics card, sound card, input and output peripherals, Network Interface Card (NIC), screen size, etc. The system may also provide recommendations for upgrading frequently used applications for the user's account. Therefore, the system may provide the user with upgrading recommendations for the complete system of the user device.

It is also an embodiment of the present invention that the CPU usage data may be stored in association with the user account and when the user wishes to make a future purchase, the CPU usage data can be used to make a recommendation.

It is also an embodiment of the present invention that the CPU usage data may be used to design other computing or consumer electronic devices. Thus, the embodiments of the present invention are directed to improving an existing computing device; providing recommendations to a user based on their specific usage requirements (as obtained from their usage data); and utilization of the CPU usage data to design the next generation of computing devices.

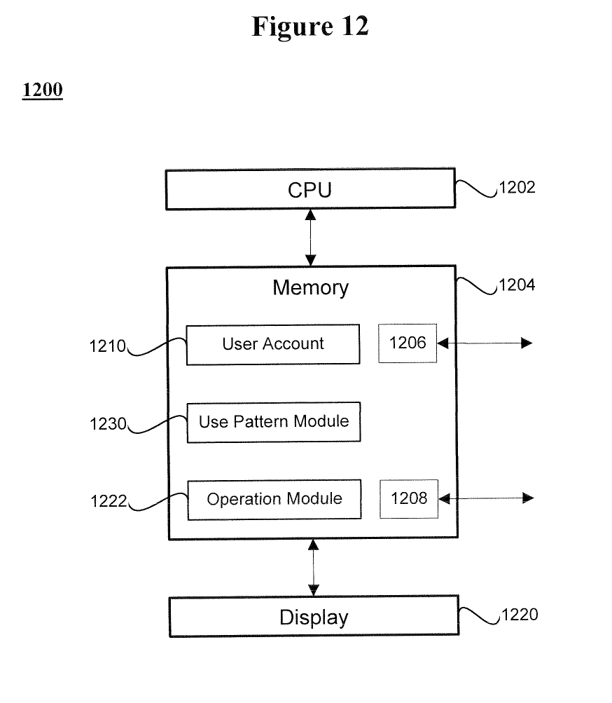

FIG. 12 shows a block diagram 1200 of a client device according to an embodiment of the present invention. (The client device is also shown in FIG. 2 as element 112.) The client device 1200, as shown in FIG. 12, includes a processor module 1202 (shown as CPU) and a memory module 1204. The memory module 1204 includes a user account module 1210 that stores user information, such as PIN, password, device identifier, serial number and other user and/or device information. Use Pattern module 1230 is used to store use pattern data for a user. This may include, for example, software operating on the device, internet sites visited, mode of operation, key strokes, troubleshooting algorithms run, requests for help, or emails to help desks or hot lines, memory use, types of programs executed (i.e., word processing, research, financial planning, spread sheets, etc.) and other information related to a particular user. Indeed, more than one user may be associated with a device and thus have an individual user account. The operation module 1222 is also used to store operational data about the device 1200. The operation module 1222 also includes memory locations that can store upgrade information and CPU state information for the device, as well as a memory location to store CPU upgrade information, typically received from a remote location, related to upgrades or modified CPU states, or modified CPU functions, and/or additional components (hardware and/or software) that will be responsive to the type of use of the device and/or programs executed by the device. Thus, a particular user may find it helpful to receive upgrades and/or recommendations for upgrades to CPU functionality for more efficient operation of their client device 1200. These CPU upgrades and CPU recommendations may be updated based on additional use pattern data.

Transmission module 1206 transmits the use pattern data to a remote location. The remote location may be one or more of remote devices, such as one or more of the server devices (104, 106, 108, and/or 10) shown in FIG. 1.

A reception module 1208 receives processed data, the processed data being a function of the use pattern data. The processed data may also identify one or more CPU upgrades or CPU modifications for the user device.

The processor module (CPU) 1202 utilizes the processed data, including the CPU recommendations and/or CPU upgrade data to modify operation of the client device. Display module 1220, which may be an LCD, plasma, CRT or other suitable display device that can display text and/or image data, displays an indication of the received processed data and displays an indication of the modified operation of the client device, and/or recommendations or a combination thereof. The modified operation may include, for example, what software is operating on the client device, the CPU operating conditions, memory allocation, troubleshooting routines, anti-virus software and other hardware and/or software operations of the client device.

Thus, a user at a client device, or terminal, 1200 can receive an indication of how their device operation has been modified based on the processed use data and what recommendations are being generated based on the use pattern data. This indication may also include device parameters and/or functions that have been optimized and parameters and/or functions that have not been optimized. It can also indicate the status of one or more troubleshooting routines or algorithms. The troubleshooting routines may be updated and/or modified based on additional use pattern data that is acquired subsequent to execution of a previous troubleshooting routine.

The use pattern data may be updated at a predetermined time interval, such as every 24 hours, every month or after new software and/or hardware has been introduced. Thus, the use pattern data module is iterative by updating the use pattern data of the device at a predetermined time interval and/or operational status.

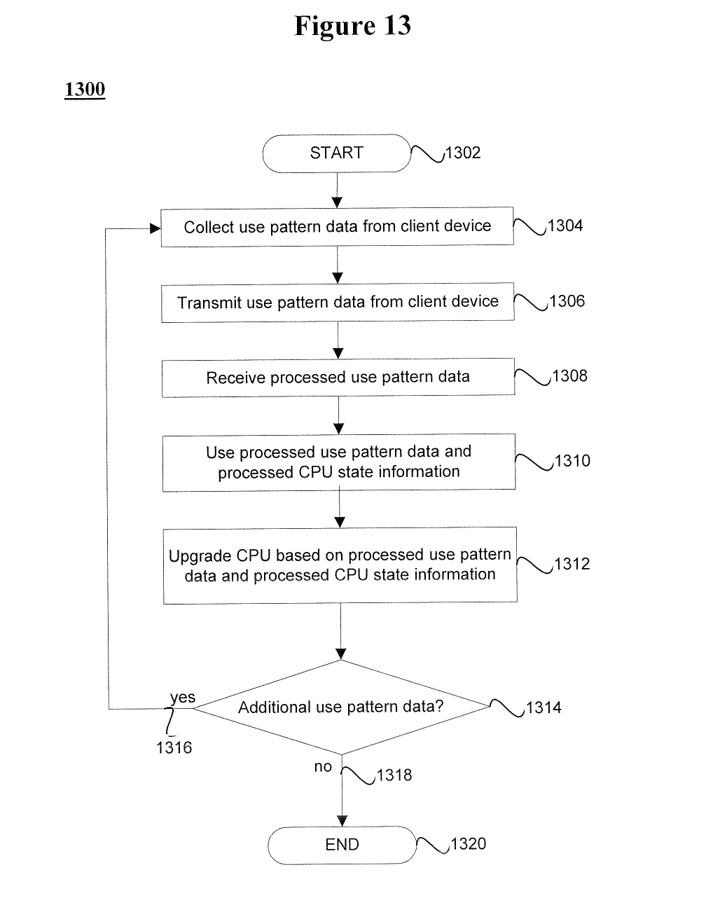

FIG. 13 shows a flowchart of steps 1300 according to an embodiment of the present invention. The steps 1300 may be stored on a suitable electronic storage medium, such as a computer-readable medium. The flowchart may be stored in a storage location, which may be any of the memory locations described herein in File Server, Data Base Server, HTTPs server, or other remote or local memory. The steps may be stored on a non-transitory computer-readable medium, or any suitable electronic storage medium or may be retrieved from a remote location. Steps 1300 begin with start step 1302. Use pattern data is collected from the client device, as shown in step 1304. The collected use pattern data, that has been collected by the user device is transmitted from the client device to a remote location, such as the servers shown in FIG. 1, as shown in step 1306. The client device may then receive processed use pattern data from a remote location, as shown in step 1308. The processed use pattern device data is based on the use pattern data that was collected by the device. The processed use pattern data may also identify one or more ways to upgrade the CPU and/or modify operation of the CPU. For example, if the use pattern data shows particular CPU operational states, a recommendation for more efficient CPU functionality may be generated. This recommendation may reflect software operating on the client device, hardware components, memory usage and other characteristics of the user using the client device. The recommendation may be transmitted to the user as well as further processed to generate recommendations for a particular user, or a class of users (e.g., all users of a particular model of client device).

The processed use pattern data including the CPU state information may then be used to modify operation of the client device and/or provide recommendations, as shown in step 1310. This modification may include retrieving additional software, suggesting additional software upgrades, suggesting additional hardware upgrades, changing the operational status of the device, troubleshooting, downloading one or more software patches, or other modification or recommendation based on the received processed data.

The result of the processed data and/or recommendations may be displayed on a display device, as shown in step 1312. This may include displaying a message regarding software upgrades, hardware upgrades, optimization of one or more device parameters, such as CPU operation, detected virus, anti-virus software or other messages and/or recommendation to a user to improve operation of the device or suggest a more suitable device or other additional devices that the user may find enhance the computing experience.

In step 1314, a determination is made whether there is any additional use pattern data. This includes use pattern data that has been generated since the previous collection of use pattern data or use pattern data that results from modified operation of the device and/or additional software/hardware. If there is additional use pattern data, “yes” line 1316 leads to step 1304 and the process repeats, as described above. If there is no additional use pattern data, “no” line 1318 leads to end step 1320.

Thus, the CPU state information obtained from the user device may be used to indicate the CPU is at p-state, c-state and s-state. The processed data includes recommendations for upgrading the CPU, when a calculated average CPU usage is greater than a predetermined threshold.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

What is claimed is:

1. A method for utilizing user feedback of a user device, comprising:
identifying CPU state information for the user device;
obtaining CPU usage when CPU is at p-state;
calculating an average CPU usage; and
upgrading CPU based on the calculated average CPU usage.

2. The method as claimed in claim 1, further comprising:
determining whether the calculated average CPU usage is greater than a predetermined threshold.

3. The method as claimed in claim 1, wherein the CPU state information indicates the CPU is at p-state, c-state and s-state.

4. The method as claimed in claim 2, further comprising:
making recommendations for upgrading the CPU, when the calculated average CPU usage is greater than the predetermined threshold.

5. The method as claimed in claim 1, further comprising:
upgrading the CPU based on a product bucket identification (ID).

6. The method as claimed in claim 1, further comprising:
creating a user account for each user; and
collecting use pattern data for each user.

7. The method as claimed in claim 5, further comprising:
identifying the product bucket identification (ID);
collecting usage information for a plurality of products having a same product bucket identification (ID); and
making recommendations for upgrading the CPU based on the product bucket identification (ID).

8. The method as claimed in claim 1, further comprising:
upgrading CPU based on the user's request.

9. The method as claimed in claim 1, wherein the upgrading step includes design modifications for other CPU devices.

10. A client device comprising:
a user account module that stores use pattern data for a user, the use pattern data including CPU state information for the user device;
a transmission module that transmits the use pattern data to a remote location;
a reception module that receives processed data, the processed data being a function of the use pattern data and the CPU state information; and
a processor module that utilizes the processed data to upgrade the CPU based on the received processed data.

11. The client device as claimed in claim 10, further comprising:
a display unit that displays an indication of the CPU status.

12. The client device as claimed in claim 10, wherein the use pattern data is updated at a predetermined time interval.

13. The client device as claimed in claim 10, wherein the CPU state information indicates the CPU is at p-state, c-state and s-state.

14. The client device as claimed in claim 10, wherein the processed data includes recommendations for upgrading the CPU, when a calculated average CPU usage is greater than a predetermined threshold.
